(19) United States
(12) Patent Application Publication
(10) Pub. No.: US 2025/0013918 A1
(43) Pub. Date: Jan. 9, 2025

(54) AUTOMATIC DECISION-MAKING FOR RE-FEEDING

(71) Applicant: TCL ZHONGHUAN RENEWABLE ENERGY TECHNOLOGY CO., LTD., Tianjin (CN)

(72) Inventors: Ming YAN, Tianjin (CN); Enhui DONG, Tianjin (CN); Xuefeng LI, Tianjin (CN); Shichao ZHANG, Tianjin (CN); Runfei GAO, Tianjin (CN)

(73) Assignee: TCL ZHONGHUAN RENEWABLE ENERGY TECHNOLOGY CO., LTD., Tianjin (CN)

(21) Appl. No.: 18/548,095

(22) PCT Filed: Jul. 31, 2023
(86) PCT No.: PCT/CN2023/110383

§ 371 Date: Aug. 27, 2023

(30) Foreign Application Priority Data
Aug. 25, 2022 (CN) 202211024756.0

(51) Int. Cl. G06N 20/00; C30B 15/20

(52) U.S. Cl. CPC G06N 20/00; C30B 15/20

(57) ABSTRACT

The present disclosure relates to automatic decision-making for re-feeding. Multi-dimensional data cleaning is performed and dimensional data warehouse is established by processing, filtering and converting basic source data of re-feeding nodes in a re-feeding process for monocrystal pulling-up into data sets easily identified and marked and establishing respective models based thereon. Basic source data of a current re-feeding nodes are obtained and converted into process parameters. The process parameters are compared with respective models in the dimensional data warehouse to obtain a first determination result. Data analysis is performed on the first determination result to determine whether an abnormality occurs in the current re-feeding process to obtain a second determination result. Decision is made automatically based on the second determination result.

### CROSS-REFERENCE TO RELATED APPLICATION

This present disclosure claims priority to and the benefit of Chinese Patent Application No. 202211024756.0, filed on Aug. 25, 2022, the disclosure of which is hereby incorporated by reference in its entirety.

### TECHNICAL FIELD

The present disclosure relates to production of photovoltaic monocrystal by pulling-up, and particularly to automatic decision-making for re-feeding.

### BACKGROUND

In the production of monocrystal by pulling-up, in order to save work time, increase an utilization rate of a quartz crucible, improve the output of a single furnace, and reduce the cost of starting the furnace, multiple feeding operations may be carried out for the single furnace. That is, multiple feeding operations may be carried out during operation of the furnace to achieve the increased feeding quantity and the reduced cost of auxiliary materials for the single furnace

In an actual production process, a series of actions such as putting a re-feeder in a sub-chamber, cycling the sub-chamber, automatic purification, declining the re-feeder, and re-feeding by the re-feeder may be performed to achieve the re-feeding. Functions of automatic lifting, cycling, and purification of the re-feeder have been realized, but the declining involves problems such as safety, incomplete fool-proof protection, system identification and the like and thus cannot be automatically controlled. It is necessary to manually operate a console to control the declining, which is time-consuming and inefficient.

### SUMMARY

In view of the above, the present disclosure provides a method of automatic decision-making for re-feeding including:
obtaining basic source data of re-feeding nodes for respective furnaces of respective series of a plurality of types in a re-feeding process for monocrystal pulling-up;
processing the obtained basic source data to filter and convert the basic source data into a plurality of parameters easily identified and marked in the re-feeding nodes, and obtaining a data set of respective values of the plurality of parameters;
establishing respective models for the plurality of the parameters by deep learning based on the data set;
performing analysis, calculation, fitting and optimization on each of the models by the deep learning to obtain a critical feeding quality, a critical crystal position, and a critical sensor weight in the re-feeding process for monocrystal pulling-up;
performing analysis and calculation on each of the models by the deep learning to obtain first basic source data of a feeding quality, a crystal position, and a sensor weight of a re-feeding node for current furnace of current series of current type;
processing the obtained first basic source data to filter and convert the first basic source data into process parameters, easily identified and marked, of the feeding quality, the crystal position, and the sensor weight;
comparing the process parameters of the feeding quality, the crystal position, and the sensor weight respectively with the critical feeding quality, the critical crystal position, and the critical sensor weight to obtain a comparison result, and determining, based on the comparison result, whether respective values of the process parameters of the re-feeding node where the monocrystal is located are reasonable to obtain a first determination result; and
performing data analysis on the first determination result by the deep learning to determine whether an abnormality occurs in a current re-feeding process to obtain a second determination result, and make a decision based on the second determination result.

In some embodiments of the present disclosure, the plurality of parameters for the re-feeding nodes correspond to respective types of the process parameters.

In some embodiments of the present disclosure, each of the plurality of parameters is established based on a process step, the feeding quality, the crystal position, and the sensor weight in one of the re-feeding nodes.

In some embodiments of the present disclosure, all of the plurality of parameters are configured to be displayed in a terminal display of a single crystal furnace.

In some embodiments of the present disclosure, the basic source data of the re-feeding nodes comprises at least one of production process data, raw auxiliary material data or quality data.

The present disclosure further provides a computer device including: a processor; and a memory storing a computer program executable by the processor to perform the above method.

The present disclosure further provides a non-transitory computer readable storage medium storing a computer program executable by a processor to perform the above method.

### BRIEF DESCRIPTION OF THE DRAWINGS

FIG. 1 is a flowchart of a method of automatic decision-making for re-feeding according to an embodiment of the present disclosure.

FIG. 2 illustrates a flowchart of a system of automatic decision-making for re-feeding according to an embodiment of the present disclosure.

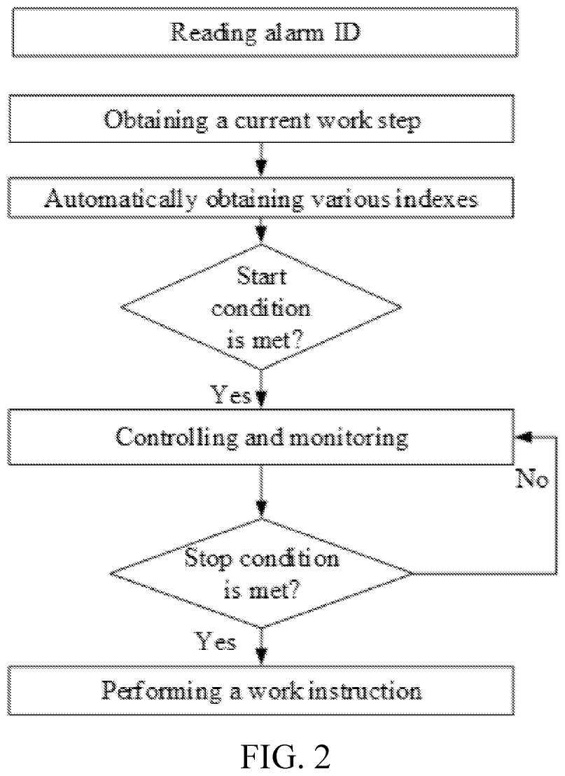

### DETAILED DESCRIPTION

The present disclosure is further described below with reference to the embodiments and the accompanying drawings.

In order to make the objects, technical solutions and advantages of the present disclosure clearer, the present disclosure will now be described in further detail with reference to the following detailed description, taken in conjunction with the accompanying drawings. It should be understood that these descriptions are exemplary only and are not intended to limit the scope of the present disclosure. In addition, in the following description, descriptions of well-known structures and techniques are omitted so as not to unnecessarily obscure the concepts of the present disclosure.

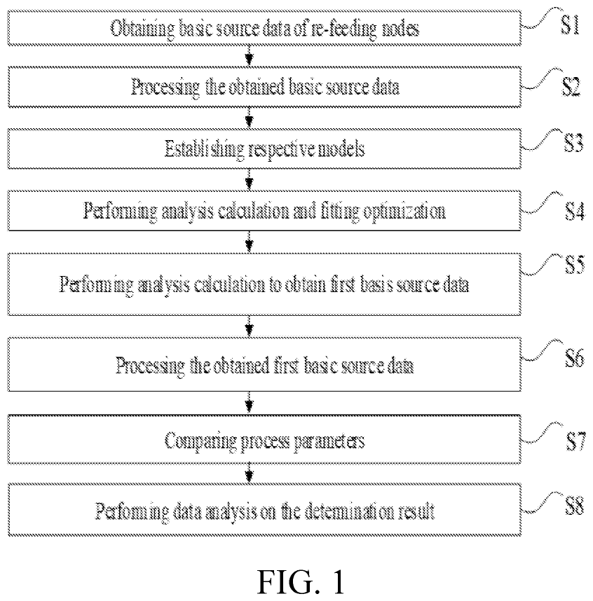

As shown in FIG. 1, an embodiment of the present disclosure provides a method of automatic decision-making for re-feeding, including following steps S1-S8.

At step S1, basic source data of re-feeding nodes for respective furnaces of respective series of a plurality of types in a re-feeding process for monocrystal pulling-up is obtained.

Specifically, the basic source data of the re-feeding nodes includes at least one of production process data, raw auxiliary material data or quality data.

The production process data may include a device name, start and end time, a batch number, a process pattern, a recipe name, a diameter measurement value, a thermal field temperature value, a main heater power measurement, a bottom heater power measurement, an actual crystal pulling speed, and the like.

The raw auxiliary material data may include a material preparation date, a dosing number, a personnel shift, a furnace time, a workpiece specification, a crucible type, a crucible origin, a raw polycrystalline weight, a recovery material proportion, an overall weight, and the like.

The quality data may include monocrystal numbering, length, weight, diameter, resistivity, lifetime, oxygen content, carbon content, defects, and the like.

At step S2, the obtained basic source data is processed to filter and convert the basic source data into a plurality of parameters easily identified and marked in the re-feeding nodes, and obtaining a data set of respective values of the plurality of parameters.

Specifically, the basic source data is processed, filtered, and converted into a plurality of parameters easily identified and marked in the re-feeding nodes, to obtain a data set of respective values of the parameters. That is, the scattered, chaotic, and standard non-uniform source data in the input basic source data are integrated, and then converted into a common parameter data set in the workpiece processing node, thereby providing a basis for subsequent parameter comparison and decision analysis.

Further, each of the plurality of parameters is established based on a process step, the feeding quality, the crystal position, and the sensor weight in one of the re-feeding nodes.

Further, all of the plurality of parameters are configured to be displayed in a terminal display of a single crystal furnace.

At step S3, respective models are established for the plurality of the parameters by deep learning based on the data set.

Specifically, the respective models are established for each of the parameters by the deep learning method, so as to monitor the node analysis and determination of all the workpieces during the re-feeding process to obtain a monocrystal workpiece of which the quality meets the standard. The deep learning is based on a conventional deep learning model in the art of machine learning. For example, the deep learning may be based on at least one of a convolution neural network, a recurrent neural network, a generative adversarial network, or deep reinforcement learning, which are well known in the art.

At step S4, analysis, calculation, fitting and optimization are performed on each of the models by the deep learning to obtain a critical feeding quality, a critical crystal position, and a critical sensor weight in the re-feeding process for monocrystal pulling-up.

Specifically, analysis, calculation, fitting and optimization are performed on each of the models by the deep learning to obtain a critical feeding quality, a critical crystal position, and a critical sensor weight in the re-feeding process for monocrystal pulling-up.

At step S5, analysis and calculation are performed on each of the models by the deep learning to obtain first basic source data of a feeding quality, a crystal position, and a sensor weight of a re-feeding node for current furnace of current series of current type.

At step S6, the obtained first basic source data is processed to filter and convert the first basic source data into process parameters, easily identified and marked, of the feeding quality, the crystal position, and the sensor weight.

Further, the plurality of parameters for the re-feeding nodes correspond to respective types of the process parameters.

At step S7, the process parameters of the feeding quality, the crystal position, and the sensor weight are compared respectively with the critical feeding quality, the critical crystal position, and the critical sensor weight to obtain a comparison result, and whether respective values of the process parameters of the re-feeding node where the monocrystal is located are reasonable is determined based on the comparison result to obtain a first determination result.

At step S8, data analysis is performed on the first determination result by the deep learning to determine whether an abnormality occurs in a current re-feeding process to obtain a second determination result, and make a decision based on the second determination result.

A system of automatic decision-making for re-feeding includes:
a source data obtaining unit for obtaining basic source data of re-feeding nodes for respective furnaces of respective series of a plurality of types in a re-feeding process for monocrystal pulling-up;
a source data processing unit for processing the obtained basic source data to filter and convert the basic source data into a plurality of parameters easily identified and marked in the re-feeding nodes, and obtaining a data set of respective values of the plurality of parameters; a model establishing unit for establishing respective models for the plurality of the parameters by deep learning based on the data set;
a data cleaning unit for performing multi-dimensional data cleaning on each of the models to establish dimensional data warehouse of the re-feeding process for monocrystal pulling-up; a data comparison unit for comparing process parameters with respective models to obtain a first determination result; and a big data platform unit for performing a big data analysis on the first determination result, to determine whether an abnormality occurs in a current re-feeding process to obtain a second determination result, and make a decision based on the second determination result.

Further, the plurality of parameters for the re-feeding nodes correspond to respective types of the process parameters;
each of the plurality of parameters is established based on a process step, the feeding quality, the crystal position, and the sensor weight in one of the re-feeding nodes; and all of the plurality of parameters are configured to be displayed in a terminal display of a single crystal furnace.

Further, the basic source data of the re-feeding nodes includes at least one of production process data, raw auxiliary material data or quality data.

Another embodiment of the present disclosure further provides a computer device, including: a processor; and a memory storing a computer program executable by the processor to perform the steps of the method of automatic decision-making for re-feeding as described in any one of the above.

Another embodiment of the present disclosure further provides a non-transitory computer readable storage medium stores a computer program executable by a processor to perform the steps of the method of automatic decision-making for re-feeding as described in any one of the above.

The advantages and beneficial effects achieved by the present disclosure are:
1. the method of automatic decision-making for re-feeding, the system of automatic decision-making for re-feeding, the computer device and the non-transitory computer readable storage medium designed by the present disclosure are used to, with an EAP data collector, acquire and store real-time data of the re-feeding production process in a database, so that the main data such as the process step, the feeding quality, the crystal position and the sensor weight in the production process can be read and stored at the second level. A single crystal furnace communication function module is established based on an API interface to realize a real-time communication function between the model and the single crystal furnace, where the model reads operation process data in real time through the communicated data interface and realizes control capability of each device instruction (such as crystal rising and crystal falling) of the single crystal furnace. The control boundary logic of each index condition is configured by processing the acquisition data from the database, and the operation index state of the furnace is compared with the setting logic in real time to determine whether the control condition is reached or not, so as to realize the control function. The furnace is controlled to execute a re-feeder falling or stopping instruction by calling a furnace communication function module when the conditions are met by reading the data such as the sensor weight, the crystal position and the like in real time.
2. the technical solution of the present disclosure can implement an automatic declining function of the re-feeder and avoids an abnormal occurrence in the control process by performing data acquisition, data processing, and increasing logic identification for a re-feeding process of the monocrystal pulling-up in the re-feeding process, thereby improving operation efficiency and reducing the occurrence of an abnormal accident. The control of the model is based on performing data processing on the data of the re-feeding process, and determine a control state of the pulling-up single crystal furnace to output a control signal, thereby realizing the functions of determining the condition of automatic declining of the re-feeder, fool-proof protection, declining control, and an alarm output. Automatic control is realized.

It should be understood that the above-described embodiments of the present disclosure are merely illustrative or explanatory of the principles of the present disclosure and are not to be construed as limiting the present disclosure. Accordingly, any modifications, equivalents, modifications and the like which may be made without departing from the spirit and scope of the present disclosure are intended to be included within the scope of the present disclosure. Furthermore, the appended claims of the present disclosure are intended to cover all changes and modifications that fall within the scope and boundaries of the appended claims, or equivalents of such scope and boundaries.

What is claimed is:

1. A method of automatic decision-making for re-feeding, comprising:
obtaining basic source data of re-feeding nodes for respective furnaces of respective series of a plurality of types in a re-feeding process for monocrystal pulling-up;
processing the obtained basic source data to filter and convert the basic source data into a plurality of parameters easily identified and marked in the re-feeding nodes, and obtaining a data set of respective values of the plurality of parameters;
establishing respective models for the plurality of the parameters by deep learning based on the data set;
performing analysis, calculation, fitting and optimization on each of the models by the deep learning to obtain a critical feeding quality, a critical crystal position, and a critical sensor weight in the re-feeding process for monocrystal pulling-up;
performing analysis and calculation on each of the models by the deep learning to obtain first basic source data of a feeding quality, a crystal position, and a sensor weight of a re-feeding node for current furnace of current series of current type;
processing the obtained first basic source data to filter and convert the first basic source data into process parameters, easily identified and marked, of the feeding quality, the crystal position, and the sensor weight;
comparing the process parameters of the feeding quality, the crystal position, and the sensor weight respectively with the critical feeding quality, the critical crystal position, and the critical sensor weight to obtain a comparison result, and determining, based on the comparison result, whether respective values of the process parameters of the re-feeding node where the monocrystal is located are reasonable to obtain a first determination result; and
performing data analysis on the first determination result by the deep learning to determine whether an abnormality occurs in a current re-feeding process to obtain a second determination result, and make a decision based on the second determination result.

2. The method of claim 1, wherein the plurality of parameters for the re-feeding nodes correspond to respective types of the process parameters.

3. The method of claim 2, wherein each of the plurality of parameters is established based on a process step, the feeding quality, the crystal position, and the sensor weight in one of the re-feeding nodes.

4. The method of claim 3, wherein all of the plurality of parameters are configured to be displayed in a terminal display of a single crystal furnace.

5. The method of claim 1, wherein the basic source data of the re-feeding nodes comprises at least one of production process data, raw auxiliary material data or quality data.

6. The method of claim 2, wherein the basic source data of the re-feeding nodes comprises at least one of production process data, raw auxiliary material data or quality data.

7. The method of claim 3, wherein the basic source data of the re-feeding nodes comprises at least one of production process data, raw auxiliary material data or quality data.

8. The method of claim 4, wherein the basic source data of the re-feeding nodes comprises at least one of production process data, raw auxiliary material data or quality data.

9. A computer device comprising:
a processor; and
a memory storing a computer program executable by the processor to perform operations comprising:
obtaining basic source data of re-feeding nodes for respective furnaces of respective series of a plurality of types in a re-feeding process for monocrystal pulling-up;
processing the obtained basic source data to filter and convert the basic source data into a plurality of parameters easily identified and marked in the re-feeding nodes, and obtaining a data set of respective values of the plurality of parameters;
establishing respective models for the plurality of the parameters by deep learning based on the data set;
performing analysis, calculation, fitting and optimization on each of the models by the deep learning to obtain a critical feeding quality, a critical crystal position, and a critical sensor weight in the re-feeding process for monocrystal pulling-up;
performing analysis and calculation on each of the models by the deep learning to obtain first basic source data of a feeding quality, a crystal position, and a sensor weight of a re-feeding node for current furnace of current series of current type;
processing the obtained first basic source data to filter and convert the first basic source data into process parameters, easily identified and marked, of the feeding quality, the crystal position, and the sensor weight;
comparing the process parameters of the feeding quality, the crystal position, and the sensor weight respectively with the critical feeding quality, the critical crystal position, and the critical sensor weight to obtain a comparison result, and determining, based on the comparison result, whether respective values of the process parameters of the re-feeding node where the monocrystal is located are reasonable to obtain a first determination result; and
performing data analysis on the first determination result by the deep learning to determine whether an abnormality occurs in a current re-feeding process to obtain a second determination result, and make a decision based on the second determination result.

10. The computer device of claim 9, wherein the plurality of parameters for the re-feeding nodes correspond to respective types of the process parameters.

11. The computer device of claim 10, wherein each of the plurality of parameters is established based on a process step, the feeding quality, the crystal position, and the sensor weight in one of the re-feeding nodes.

12. The computer device of claim 11, wherein all of the plurality of parameters are configured to be displayed in a terminal display of a single crystal furnace.

13. The computer device of claim 9, wherein the basic source data of the re-feeding nodes comprises at least one of production process data, raw auxiliary material data or quality data.

14. The computer device of claim 10, wherein the basic source data of the re-feeding nodes comprises at least one of production process data, raw auxiliary material data or quality data.

15. The computer device of claim 11, wherein the basic source data of the re-feeding nodes comprises at least one of production process data, raw auxiliary material data or quality data.

16. The computer device of claim 12, wherein the basic source data of the re-feeding nodes comprises at least one of production process data, raw auxiliary material data or quality data.

17. A non-transitory computer readable storage medium storing a computer program executable by a processor to perform operations comprising:
obtaining basic source data of re-feeding nodes for respective furnaces of respective series of a plurality of types in a re-feeding process for monocrystal pulling-up;
processing the obtained basic source data to filter and convert the basic source data into a plurality of parameters easily identified and marked in the re-feeding nodes, and obtaining a data set of respective values of the plurality of parameters;
establishing respective models for the plurality of the parameters by deep learning based on the data set;
performing analysis, calculation, fitting and optimization on each of the models by the deep learning to obtain a critical feeding quality, a critical crystal position, and a critical sensor weight in the re-feeding process for monocrystal pulling-up;
performing analysis and calculation on each of the models by the deep learning to obtain first basic source data of a feeding quality, a crystal position, and a sensor weight of a re-feeding node for current furnace of current series of current type;
processing the obtained first basic source data to filter and convert the first basic source data into process parameters, easily identified and marked, of the feeding quality, the crystal position, and the sensor weight;
comparing the process parameters of the feeding quality, the crystal position, and the sensor weight respectively with the critical feeding quality, the critical crystal position, and the critical sensor weight to obtain a comparison result, and determining, based on the comparison result, whether respective values of the process parameters of the re-feeding node where the monocrystal is located are reasonable to obtain a first determination result; and
performing data analysis on the first determination result by the deep learning to determine whether an abnormality occurs in a current re-feeding process to obtain a second determination result, and make a decision based on the second determination result.

18. The computer readable storage medium of claim 17, wherein the plurality of parameters for the re-feeding nodes correspond to respective types of the process parameters.

19. The computer readable storage medium of claim 18, wherein each of the plurality of parameters is established based on a process step, the feeding quality, the crystal position, and the sensor weight in one of the re-feeding nodes.

20. The computer readable storage medium of claim 19, wherein all of the plurality of parameters are configured to be displayed in a terminal display of a single crystal furnace.
